(19) United States
(12) Patent Application Publication
(10) Pub. No.: US 2011/0184616 A1
(43) Pub. Date: Jul. 28, 2011

(54) METHOD FOR CONTROLLING THE TORQUE CONVERTER CLUTCH (TCC) PRESSURE DURING POWER DOWNSHIFT EVENTS

(75) Inventor: Vincent Holtz, Rosenwiller (FR)

(73) Assignee: GM GLOBAL TECHNOLOGY OPERATIONS LLC, Detroit, MI (US)

(21) Appl. No.: 13/120,549

(22) PCT Filed: Jul. 20, 2009
(86) PCT No.: PCT/EP2009/005434

§ 371 Date: Mar. 23, 2011

(30) Foreign Application Priority Data
Sep. 23, 2008 (GB) 0817349.4

(51) Int. Cl. F16D 48/06; F16H 61/48

(52) U.S. Cl. 701/68

(57) ABSTRACT

A method is provided for controlling the torque converter clutch (TCC) pressure during power downshift events. In order to provide a method for controlling the torque converter clutch (TCC) pressure during power downshift events, the present invention proposes that an inertia torque is computed at the beginning of the shift and that a pressure compensation is applied on the TCC during the downshift using the inertia torque. With such a pressure compensation it is possible to stay in regulation mode which improves both shift quality and fuel consumption.

### CROSS-REFERENCE TO RELATED APPLICATIONS

This application is a U.S. National-Stage entry under 35 U.S.C. §371 based on International Application No. PCT/EP2009/005434, filed Jul. 27, 2009, which was published under PCT Article 21(2) and which claims priority to British Application No. 0817349.4, filed Sep. 23, 2008, which are all hereby incorporated in their entirety by reference.

### TECHNICAL FIELD

The invention concerns a method for controlling the torque converter clutch (TCC) pressure during power downshift events.

### BACKGROUND

According to the prior art, the torque converter clutch (TCC) pressure was released during power downshift events, which means that there was no regulation of the TCC slip (difference between the engine speed and the turbine speed). In consequence, there was a high amount of TCC slip dissipating a lot of energy which increases fuel consumption. Driving comfort is also impacted since there is no real acceleration feeling which is not acceptable especially for European drivers.

It is therefore at least one objective of the invention to provide a method for controlling the torque converter clutch (TCC) pressure during power downshift events. Power downshift events are downshifts with a certain amount of throttle. In addition, other objectives, desirable features and characteristics will become apparent from the subsequent summary and detailed description, and the appended claims, taken in conjunction with the accompanying drawings and this background.

### SUMMARY

This at least one objective is achieved according to the present invention in that an inertia torque is computed at the beginning of the shift and that a pressure compensation is applied on the TCC during the downshift using the inertia torque.

With such a pressure compensation it is possible to stay in regulation mode which improves both shift quality and fuel consumption.

According to the present invention, the inertia torque is computed with the formula:

Inertia torque=RPMtoRadConv*(TurbspdFx*SftTypeFx)*(DeltaTurb*DsrdSftTime)

Where RPMtoRadConv (Rpm to rad converter constant) being equivalent to 0.104719755, TurbSpedFx being the turbine speed calibration factor, SftTypeFx being the shift type calibration factor, DeltaTurb (turbine speed delta) being the difference between the commanded turbine speed and the attained turbine speed, and DsrdSftTime being the desired shift time.

In a preferred embodiment of the invention, TCC Torque for Base operating point, used to compute the TCC pressure, is ramped down during delay phase to the inertia torque level, TCC is maintained during time phase at the inertia torque level and TCC is ramped up to the engine torque level.

With other words, TCC Torque for Base operating point, used to compute the TCC pressure, is ramped down during delay phase from the engine torque to the engine torque minus inertia torque. During time phase, TCC Torque for Base operating point is maintained at engine torque minus inertia torque. In torque phase, TCC Torque for Base operating point is ramped up from engine torque minus inertia torque to engine torque.

The TCC pressure is equal to the base operating point (BOP) plus the ramp pressure plus the adapt pressure. The BOP represents the theoretical pressure that should be sufficient to regulate the TCC slip during steady state conditions (i.e. without any throttle and torque perturbations). This pressure is mainly based on the engine torque. The on inertia compensation (OIC) has been designed to compute an inertia torque compensation during power downshift events, inertia that will be removed to the engine torque used to calculate the BOP. This will allow the TCC to stay in the regulation mode during the shift. The resulting torque (engine torque minus inertia torque) used to compute the BOP is named “torque for BOP”.

According to an other embodiment of the invention, the first level of compensation is stored if another shift is commanded before the compensation of the first shift is terminated, the second shift variables are updated and TCC Torque for Base operating point is ramped directly form the stored first level of compensation to the second inertia torque level.

In another embodiment of the invention, a peak of torque compensation is provided in order to compensate undesired peaks of torque.

### BRIEF DESCRIPTION OF THE DRAWINGS

The present invention will hereinafter be described in conjunction with the following drawing figures, wherein like numerals denote like elements, and:

FIG. 1 shows a schematic representation of the torque compensation according to the present invention;

FIGS. 2a to 2e show representations of factors taken into account for computing the inertia torque compensation; and

FIG. 3 shows a typical inertia compensation scenario with two chained power downshifts.

### DETAILED DESCRIPTION

The following detailed description is merely exemplary in nature and is not intended to limit application and uses. Furthermore, there is no intention to be bound by any theory presented in the preceding background or summary or the following detailed description.

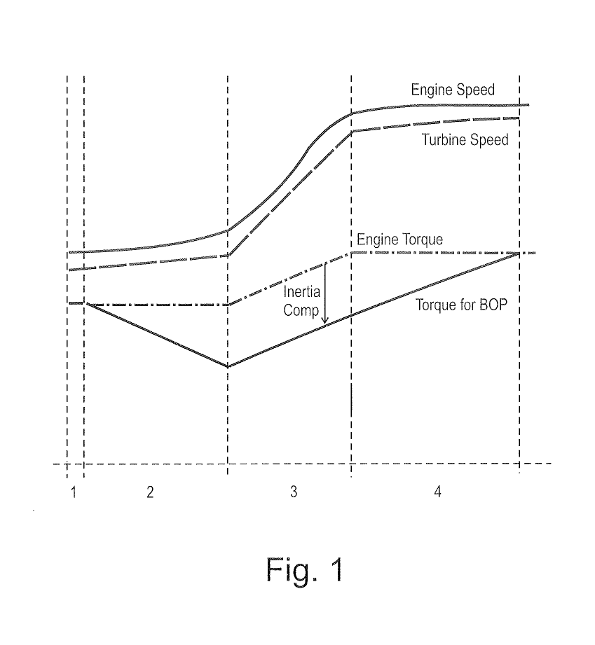

Referring to FIG. 1, the on inertia compensation (OIC) is computed at the beginning of the shift using several timing information coming from clutch control algorithms (stage 1) After being initialized, the OIC application will be based on the shift phase as depicted in FIG. 1.

During delay phase, the torque for BOP is ramped down to the inertia torque level, i.e., from the engine torque to the engine torque minus inertia torque (stage 2).

In time phase, the torque for BOP remains at the inertia torque level, which means engine torque minus inertia torque (stage 3).

Finally, in torque phase, the torque for BOP ramps up to the normal torque level, i.e. from engine torque minus inertia torque to engine torque (stage 4).

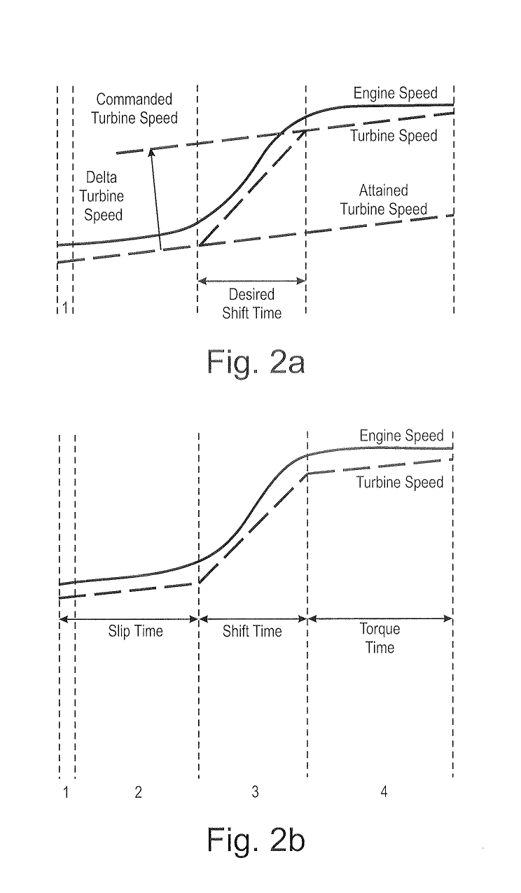

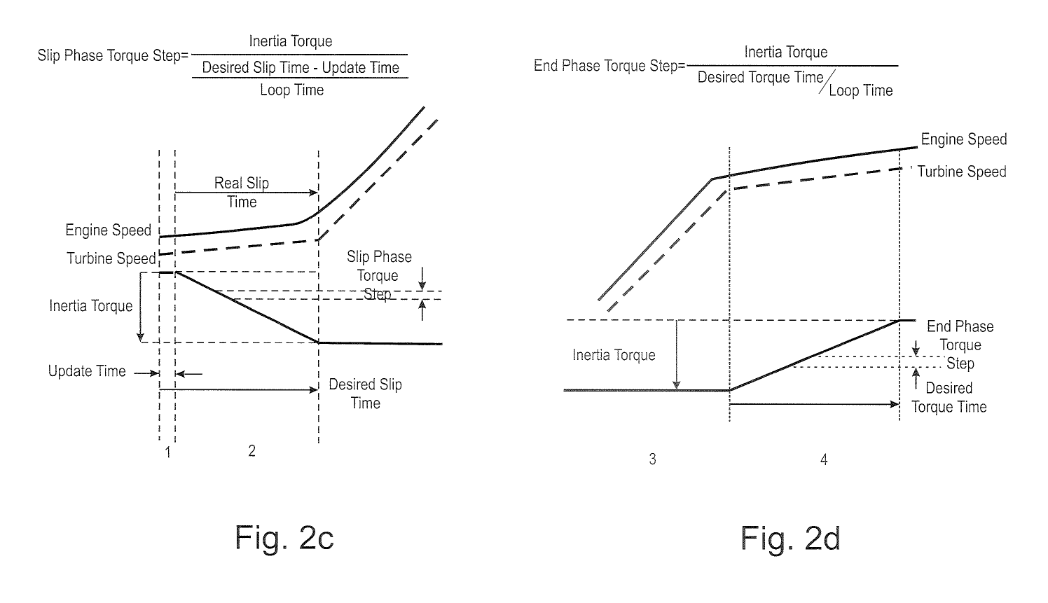

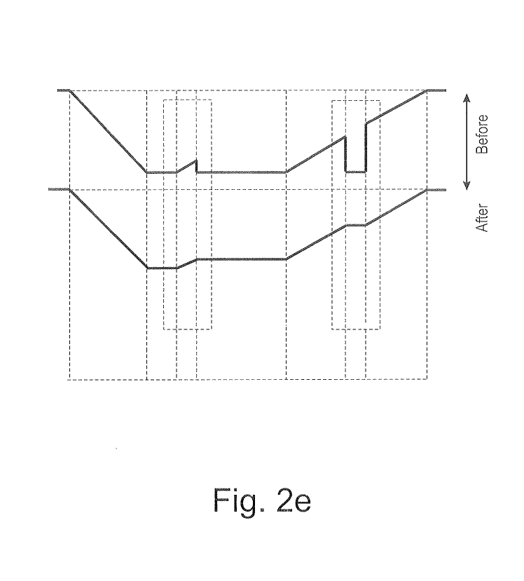

FIG. 2a shows a graphic representation of some factors used for computing the inertia torque. The engine speed increases during the shift operation. The delta turbine speed is the difference between the commanded turbine speed and the attained turbine speed. During the desired shift time, the turbine speed increases from the attained turbine speed to the commanded turbine speed.

It is to be noted that several conditions have to be fulfilled in order to launch the update function:
update is only possible in the shift delay phase,
update is only possible if the variables for this shift have not already been updated,
update is only possible if a downshift is in progress, and
update is only possible if an update is allowed.

An update will only be allowed if normal downshift (power downshift or skip via neutral shift) is commanded in TCC On mode. When a downshift is commanded and coast mode is still on, it is necessary to wait in order to know that the downshift is a power on. Otherwise, the update is not allowed.

If update is allowed, the update is only performed after an amount of time to ensure that all information to be retrieved from the clutch control algorithms has been updated.

As shown in FIG. 2b, several information coming from the clutch control algorithms is used for updating all the compensation variables. The desired slip time is used to compute inertia torque step to remove each loop to the engine torque during the delay phase. The desired shift time is used to compute the inertia torque level. The desired torque time is used to compute inertia torque step to add each loop to go back to the uncompensated engine torque level during the end phase. It is to be noted in this context, that minimum and maximum values and also calibration factors are applied on these desired times.

FIG. 2c shows graphic representations of the factors entering into the computation of the torque step calculation details for the slip phase and FIG. 2d for the end phase as well as the corresponding formulas.

Some shift phase bleep could occur during the downshift event leading to peak of torque compensation in shift phase and going in end phase for a few loops or in end phase and going back in time phase for a few loops. Therefore, a shift phase blip detection is useful in order to avoid peak of torque compensation as shown in FIG. 2e.

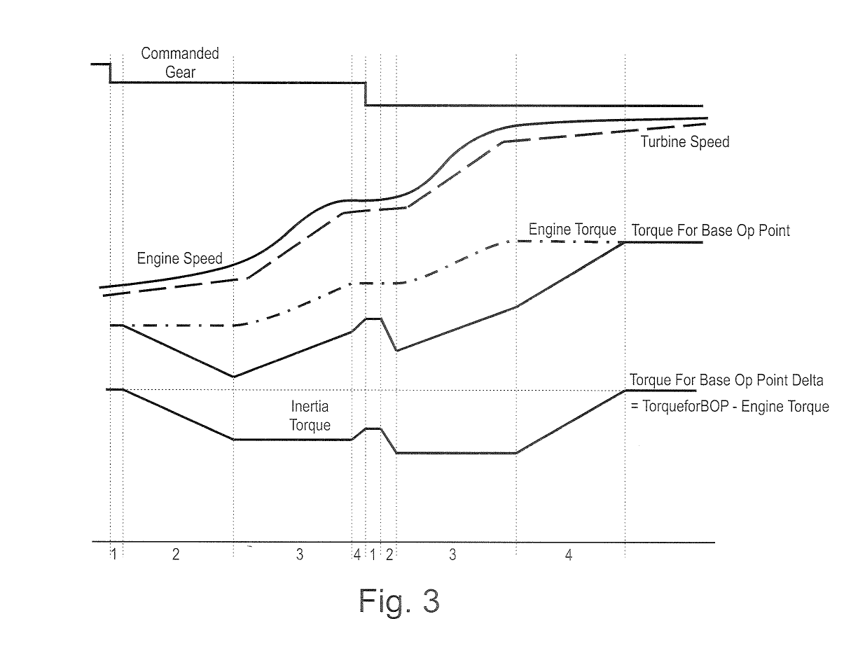

It is further useful to handle chained downshifts in a smart way. Instead of ramping up to the torque for BOP at the end of the first shift and ramping down to the inertia level of the second shift, it is possible to detect if a second shift has been commanded. If another shift has been commanded and the compensation of the first shift is going to be finished, the first level of compensation is stocked, the second shift variables are updated and TCC Torque for Base operating point is ramped directly form the stored first level of compensation to the second inertia torque level as shown in FIG. 3.

While at least one exemplary embodiment has been presented in the foregoing detailed summary and description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A method for controlling the torque converter clutch (TCC) pressure during a downshift, comprising:
computing an inertia torque at a beginning of a shift; and
applying a pressure compensation on the TCC during the downshift using the inertia torque.

2. The method of claim 1, wherein the computing the inertia torque is computed by:
Inertia torque=RPMtoRadConv*(TurbspdFx*SftTypeFx)*(DeltaTurb*DsrdSftTime),
Where: RPMtoRadConv (Rpm to rad converter constant) being equivalent to 0.104719755,
TurbSpedFx being the turbine speed calibration factor,
SftTypeFx being the shift type calibration factor,
DeltaTurb (turbine speed delta) being the difference between the commanded turbine speed and the attained turbine speed, and
DsrdSftTime being the desired shift time.

3. The method of claim 1, further comprising:
ramping down the the TCC Torque for a Base Operating Point, which is used to compute the TCC pressure, during a delay phase to an inertia torque level;
maintaining TCC during a time phase at the inertia torque level; and
ramping up the TCC to an engine torque level.

4. The method of claim 1, further comprising:
storing a first level of compensation if another shift is commanded before the compensation of the first shift is terminated; and
updating second shift variables; and
ramping TCC directly form the stored first level of compensation to the second inertia torque level.

5. The method of claim 1, further comprising providing a peak of torque compensation in order to compensate undesired peaks of torque.
